(19) United States
(12) Patent Application Publication
(10) Pub. No.: US 2024/0079553 A1
(43) Pub. Date: Mar. 7, 2024

(54) ELECTRODE BODY OF NON-AQUEOUS ELECTROLYTE RECHARGEABLE BATTERY AND NON-AQUEOUS ELECTROLYTE RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Yoshinori KUDO, Toyohashi-shi (JP); Naoki WAKAMATSU, Toyohashi-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/240,243

(22) Filed: Aug. 30, 2023

(30) Foreign Application Priority Data
Sep. 1, 2022 (JP) 2022-139404

(51) Int. Cl. H01M 4/133; H01M 4/66; H01M 10/0525; H01M 10/056

(52) U.S. Cl. CPC H01M 4/133; H01M 4/663; H01M 10/0525; H01M 10/056; H01M 2004/021

(57) ABSTRACT

An electrode body of a non-aqueous electrolyte rechargeable battery includes a positive electrode, a negative electrode, and a separator. The negative electrode includes a current collector and an active material layer. The active material layer includes active material particles. The active material particles have a volume distribution including a first peak corresponding to a first particle size and a second peak corresponding to a second particle size smaller than the first particle size. The first particle size is in a range of 7.0 μm to 9.0 μm. The second particle size is in a range of 0.8 μm to 1.0 μm. The separator has a surface roughness of 1.54 μm or greater. A peak ratio of a volume of the active material particles of the second peak to a volume of the active material particles of the first peak is in a range of 0.42 to 0.71.

### BACKGROUND

### 1. Field

The present disclosure relates to an electrode body of a non-aqueous electrolyte rechargeable battery and a non-aqueous electrolyte rechargeable battery.

### 2. Description of Related Art

The negative electrode of a typical non-aqueous electrolyte rechargeable battery includes a current collector and an active material layer applied to at least one surface of the current collector. The active material layer includes active material particles. Such active material particles are of, for example, a carbon material such as graphite.

Japanese Laid-Open Patent Publication No. 2012-256543 describes active material particles containing Si. The active material particles described in Japanese Laid-Open Patent Publication No. 2012-256543 include large particles and small particles. The small particles have a particle size of one-half of that of the large particles. The large particles have a particle size of 1.4 μm to 10 μm. The small particles have a particle size of less than 1.38 μm. The small particles enter and fill the gaps between the large particles.

When the rechargeable battery includes a negative electrode having an active material layer containing active material particles of a carbon material, there may be a need to reduce the battery resistance and prolong the battery life.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electrode body of a non-aqueous electrolyte rechargeable battery is provided. The electrode body includes a positive electrode, a negative electrode, and a separator arranged between the positive electrode and the negative electrode. The negative electrode includes a current collector and an active material layer applied to at least one surface of the current collector. The active material layer includes active material particles of different particle sizes formed from a carbon material. The active material particles have a volume distribution with respect to particle size, the volume distribution including a first peak corresponding to a first particle size and a second peak corresponding to a second particle size that is smaller than the first particle size. The first particle size is in a range of 7.0 μm to 9.0 μm. The second particle size is in a range of 0.8 μm to 1.0 μm. The separator has a surface roughness of 1.54 μm or greater. A peak ratio that is a ratio of a volume of the active material particles of the second peak to a volume of the active material particles of the first peak is in a range of 0.42 to 0.71.

In another general aspect, a non-aqueous electrolyte rechargeable battery is provided. The non-aqueous electrolyte rechargeable battery includes the above electrode body, a non-aqueous electrolyte, and a battery case accommodating the electrode body and the non-aqueous electrolyte.

Other features and aspects will be apparent from the following detailed description, the drawings, and the claims.

### BRIEF DESCRIPTION OF THE DRAWINGS

FIG. 1 is a perspective view of a non-aqueous electrolyte rechargeable battery in accordance with one embodiment.

FIG. 2A is a cross-sectional view of an electrode body of FIG. 1.

FIG. 2B is a partially enlarged cross-sectional view of the electrode body.

FIG. 3 is a graph showing a volume distribution of active material particles forming an active material layer of a negative electrode with respect to the particle size.

FIG. 4 is a table showing the surface roughness of a separator, a peak ratio, the DC resistance ratio of a battery, and a battery capacity retention ratio of a comparative example, examples, and reference examples.

FIG. 5 is a graph showing the relationship between the surface roughness of a separator and the DC resistance ratio of a battery for each peak ratio.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

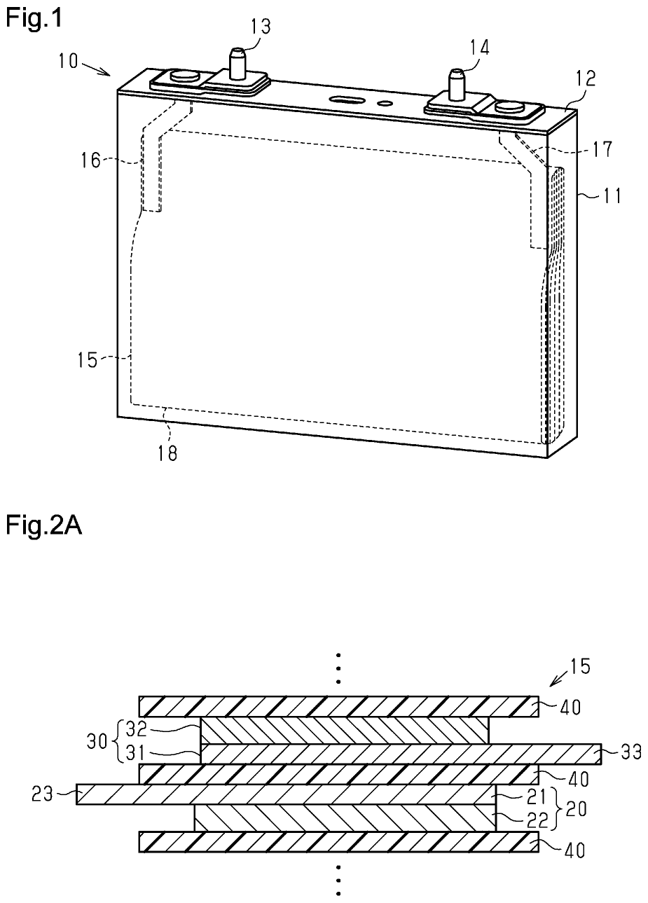

An electrode body of a non-aqueous electrolyte rechargeable battery and a non-aqueous electrolyte rechargeable battery according to one embodiment will now be described with reference to FIGS. 1 to 5.

In the present embodiment, the non-aqueous electrolyte rechargeable battery is embodied to a lithium ion battery (hereinafter referred to as battery).

Battery Case 10

As shown in FIG. 1, the battery includes a battery case 10. The battery case 10 includes a case body 11 and a lid 12.

The case body 11 accommodates an electrode body 15 and non-aqueous electrolyte 18.

A negative electrode external terminal 13 and a positive electrode external terminal 14 that are used to charge and discharge power are arranged on the outer surface of the lid 12. A collecting portion 16 and a collecting portion 17 are arranged on the inner surface of the lid 12.

Non-Aqueous Electrolyte 18

The non-aqueous electrolyte 18 is a composition in which supporting salt is contained in a non-aqueous solvent. The non-aqueous solvent is, for example, ethylene carbonate (EC). The non-aqueous solvent may be one type or two or more types of materials selected from the group including propylene carbonate (PC), diethyl carbonate (DEC), dimethyl carbonate (DMC), ethyl methyl carbonate (EMC), and the like.

Examples of the supporting salt include LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like. The supporting salt may be one type or two or more types of lithium compounds (lithium salts) selected from the above examples. Thus, the non-aqueous electrolyte 18 contains a lithium compound.

Electrode Body 15

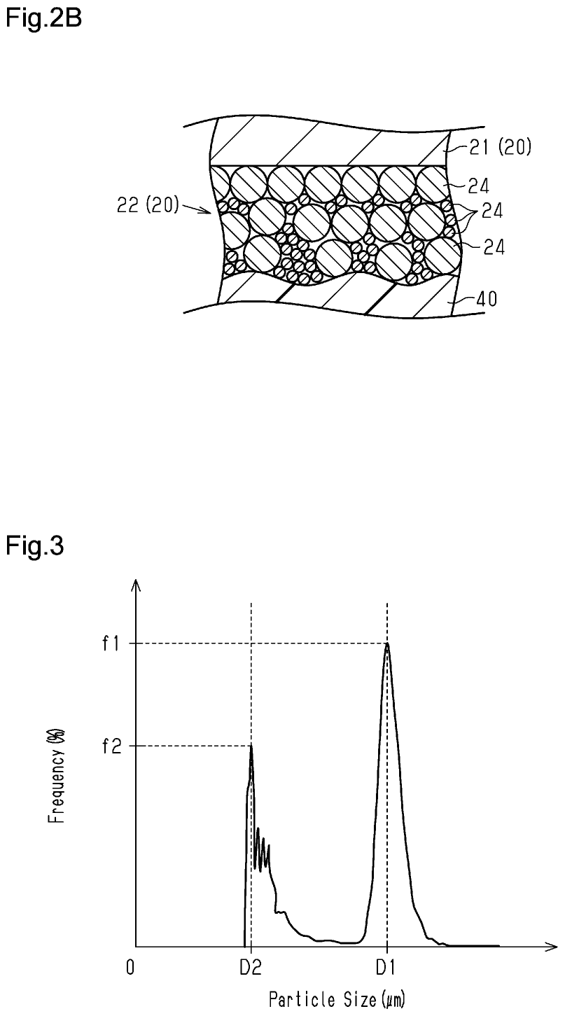

As shown in FIG. 2A, the electrode body 15 includes a negative electrode 20, a positive electrode 30, and flat separators 40 arranged between the positive electrode 30 and the negative electrode 20.

The electrode body 15 is formed, for example, by rolling a stack of the negative electrode 20, the positive electrode 30, and the separators 40.

Negative Electrode 20

As shown in FIGS. 2A and 2B, the negative electrode 20 includes a current collector 21 and an active material layer 22. The active material layer 22 is applied to one surface of the current collector 21.

The current collector 21 is formed by, for example, a copper foil. The current collector 21 functions to collect electricity from the active material layer 22.

The current collector 21 includes a connection portion 23. The connection portion 23 is located at, for example, one end of the current collector 21 in the rolling axis direction of the stack. The connection portion 23 is free from the active material layer 22. The connection portion 23 of the negative electrode 20 is connected to the negative electrode external terminal 13 by the collecting portion 16 (refer to FIG. 1).

The active material layer 22 includes active material particles 24 of a carbon material. The active material particles 24 are, for example, graphite.

The negative electrode 20 is formed by, for example, kneading the active material particles 24, a solvent, and a binder (not shown) into a paste of active material. The active material paste is then applied to the current collector 21 and dried.

The graph of FIG. 3 shows the volume distribution of the active material particles 24 with respect to particle size. The active material particles 24 form the active material layer of the negative electrode. That is, the graph of FIG. 3 shows a volume-based particle size distribution curve of the active material particles 24. In this volume distribution, the horizontal axis represents the particle size (μm) and the vertical axis represents the frequency (%). As shown in FIG. 3, the volume distribution of the active material particles 24 has a first peak f1 at a first particle size D1, and a second peak f2 at a second particle size D2 that is smaller than the first particle size D1. In one example, the volume distribution of the active material particles 24 with respect to particle size includes the first peak f1 that corresponds to the first particle size D1 and is the largest peak, and the second peak f2 that corresponds to the second particle size D2 and is the second largest peak.

The first particle size D1 is in a range of 7.0 μm to 9.0 μm. The first particle size D1 of the present embodiment is 8.0 μm.

The second particle size D2 is in a range of 0.8 μm to 1.0 μm. The second particle size D2 of the present embodiment is 0.8 μm.

The particle size was measured through an image-based particle size distribution measurement method using Morphologi G3 (developed by Malvern Panalytical).

The first peak f1 was greater than the second peak f2.

When the ratio of the volume of the active material particles 24 at the second peak f2 to the volume of the active material particles 24 at the first peak f1 is defined as a peak ratio Rt (=f2/f1), the peak ratio Rt was, for example, in a range of 0.42 to 0.71. The peak ratio Rt may be in a range of 0.42 to 0.61. In other words, the peak ratio Rt is the ratio of the total volume of the active material particles 24 having the second particle size D2 to the total volume of the active material particles 24 having the first particle size D1. In another example, the peak ratio Rt may be the ratio of the peak height of the second peak f2 to the peak height of the first peak f1 in the volume-based particle size distribution curve of the active material particles 24.

Positive Electrode 30

As shown in FIG. 2A, the positive electrode 30 includes a current collector 31 and an active material layer 32. The active material layer 32 is applied to one surface of the current collector 31.

The current collector 31 is formed by, for example, an aluminum foil or aluminum alloy foil. The current collector 31 functions to collect electricity from the active material layer 32.

The current collector 31 includes a connection portion 33. The connection portion 33 is located, for example, at the end of the current collector 31 that is opposite the end of the current collector 21 in the rolling axis direction of the stack. The connection portion 33 is free from the active material layer 32. The connection portion 33 of the positive electrode 30 is connected to the positive electrode external terminal 14 by the collecting portion 17 (refer to FIG. 1).

The active material layer 32 includes active material particles and a conductive material (not shown).

The active material particles may be a material that has the capability to store and release lithium, for example, lithium cobalt oxide (LiCoO₂), lithium manganese oxide (LiMn₂O₄), lithium nickel oxide (LiNiO₂), or the like. Alternatively, the active material particles may be a material in which LiCoO₂, LiMn₂O₄, and LiNiO₂ are mixed at a given ratio.

The conductive material may be, for example, graphite or carbon black such as acetylene black (AB), Ketjen black, or the like.

The positive electrode 30 is formed by, for example, kneading active material particles, a conductive material, a solvent, and a binder (not shown) into a paste of active material paste. The active material paste is applied to the current collector 31 and dried.

Separator 40

With reference to FIG. 2A, each separator 40 is a porous nonwoven fabric of synthetic resin or a porous film of synthetic resin. Examples of the synthetic resin include polypropylene, polyethylene, polyolefin, and polyvinyl chloride.

The surface roughness Ra of each separator 40 is 1.54 μm or greater or 2.29 μm or greater.

The upper limit value of the surface roughness Ra of the separator 40 is not particularly limited, but may be 5.2 μm or less or 3.27 μm or less. If the surface roughness Ra exceeds the upper limit value, a shutdown time required for the battery to shut down upon the generation of abnormal heat will be shorter than the time specified by safety standards.

The surface roughness Ra of the separators 40 was measured with a Shape Measurement Laser Microscope VK-X100 (manufactured by KEYENCE CORPORATION).

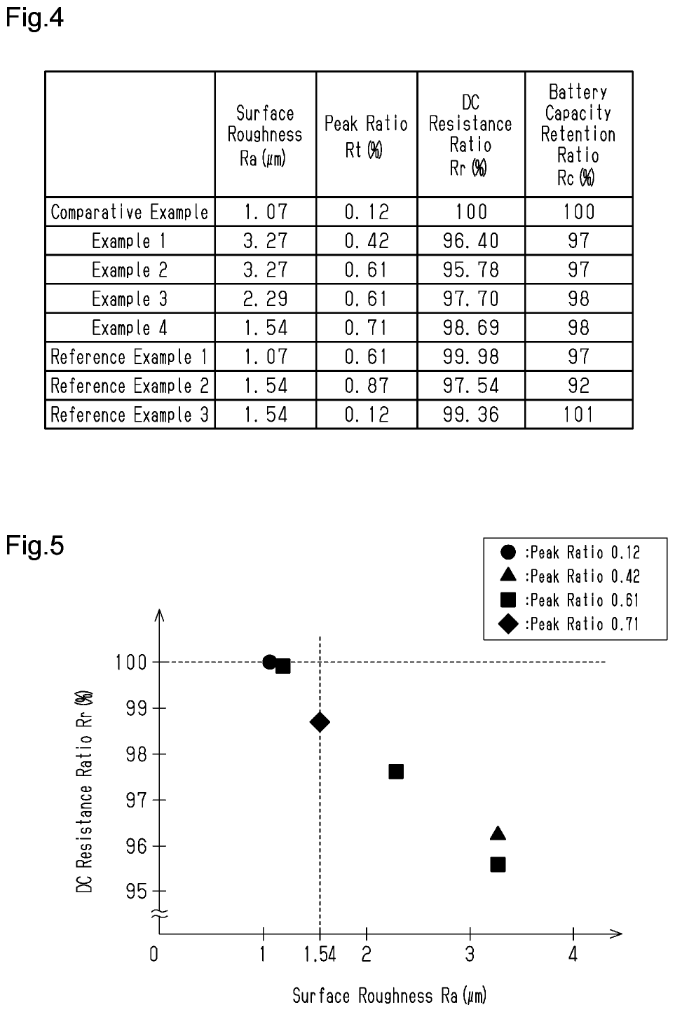

Measurement results of the DC resistance under a battery temperature of 25° C. and the battery capacity retention rate after ten days will now be described with reference to FIG. 4 that compares examples 1 to 4 with a comparative example.

In the following description, the DC resistance ratio Rr of a battery in each example is obtained by dividing the DC resistance value of the battery when the temperature of that battery is 25° C. by the DC resistance value of the battery in the comparative example when the temperature that battery is 25° C. A battery capacity retention ratio Rc of the battery in an example is obtained by dividing a battery capacity retention rate of the example by a battery capacity retention rate in the comparative example.

The battery capacity retention rate refers to the retention rate of the battery capacity when the battery is stored at high temperature for ten days at a state of charge (SOC) of 80% under a storage temperature of 75° C.

### COMPARATIVE EXAMPLE

The surface roughness Ra of the separator 40 was 1.07 μm. The peak ratio Rt was 0.12%.

### Example 1

The surface roughness Ra of the separator 40 was 3.27 μm. The peak ratio Rt was 0.42%. The DC resistance ratio Rr was 96.4%. The battery capacity retention ratio Rc was 97%.

### Example 2

The surface roughness Ra of the separator 40 was 3.27 μm. The peak ratio Rt was 0.61%. The DC resistance ratio Rr was 95.78%. The battery capacity retention ratio Rc was 97%.

### Example 3

The surface roughness Ra of the separator 40 was 2.29 μm. The peak ratio Rt was 0.61%. The DC resistance ratio Rr was 97.7%. The battery capacity retention ratio Rc was 98%.

### Example 4

The surface roughness Ra of the separator 40 was 1.54 μm. The peak ratio Rt was 0.71%. The DC resistance ratio Rr was 98.69%. The battery capacity retention ratio Rc was 98%.

### Reference Example 1

The surface roughness Ra of the separator 40 was 1.07 μm. The peak ratio Rt was 0.61%. The DC resistance ratio Rr was 99.98%. The battery capacity retention ratio Rc was 97%.

### Reference Example 2

The surface roughness Ra of the separator 40 was 1.54 μm. The peak ratio Rt was 0.87%. The DC resistance ratio Rr was 97.54%. The battery capacity retention ratio Rc was 92%.

### Reference Example 3

The surface roughness Ra of the separator 40 was 1.54 μm. The peak ratio Rt was 0.12%. The DC resistance ratio Rr was 99.36%. The battery capacity retention ratio Rc was 101%.

Thus, when the surface roughness Ra of the separator 40 was 1.54 μm or greater, the peak ratio Rt was in the range of 0.42 to 0.71, the DC resistance ratio Rr in each example was 98.69% or less. The battery capacity retention ratio Rc in each example was 97% or greater.

In the reference example 1, the surface roughness Ra of the separator 40 is small. This increases the gas permeability. In other words, when the movement of lithium ions is restricted in the separator 40, the DC resistance value of the battery will increase.

In the reference example 2, the peak ratio Rt is large. This enlarges the surface area of the active material particles 24 and increases side reactions. This will decrease the battery capacity retention rate and shorten the battery life.

The relationship between the surface roughness Ra of the separator 40 and the DC resistance ratio Rr of the battery will now be described with reference to FIG. 5. FIG. 5 is a graph plotting the relationship between the surface roughness Ra of the separator 40 and the DC resistance ratio Rr of the battery in the comparative example, the examples 1 to 4, and the reference example 1 of FIG. 4.

As shown in FIG. 5, when the surface roughness Ra of the separator 40 is 1.54 μm or greater and the peak ratio Rt is in the range of 0.42 to 0.71, the DC resistance ratio Rr will be less than that of the comparative example that has the surface roughness Ra of 1.07 μm and the peak ratio Rt of 0.12.

For example, as shown by the three points indicating the peak ratio Rt of 0.61 (square plots in FIG. 5), the DC resistance ratio Rr decreases as the surface roughness Ra of the separator 40 increases. This is because as the surface roughness Ra of the separator 40 increases, the gas permeability of the separator 40 decreases. In other words, when lithium ions easily move in the separator 40, the DC resistance value of the battery will decrease. That is, although FIG. 4 shows data on the surface roughness Ra of the separator 40 up to 3.27 the DC resistance ratio Rr will be sufficiently less than that of the comparative example even when the surface roughness Ra of the separator 40 is greater than 3.27 μm.

The advantages of the present embodiment will now be described.

(1) The first particle size D1 is in the range of 7.0 μm to 9.0 μm. The second particle size D2 is in the range of 0.8 μm to 1.0 μm. The surface roughness Ra of the separator 40 is 1.54 μm or greater. The peak ratio Rt, which is the ratio of the volume of the active material particles 24 at the second peak f2 to the volume of the active material particles 24 at the first peak f1, is in the range of 0.42 to 0.71.

This configuration, having the above operation, reduces battery resistance and prolongs the battery life.

(2) The surface roughness Ra of the separator 40 is 2.29 μm or greater. The peak ratio Rt is in the range of 0.42 to 0.61.

With this configuration, when the surface roughness Ra of the separator 40 is 2.29 μm or greater and the peak ratio Rt is in the range of 0.42 to 0.61, the DC resistance ratio Rr of the rechargeable battery of the above configuration to that of the comparative example is 97.7% or less. Further, the battery capacity retention ratio Rc after ten days of the rechargeable battery of the above configuration to that of the comparative example is 97% or greater.

Thus, the above configuration further reduces battery resistance.

(3) The electrode body 15, arranged in the non-aqueous electrolyte rechargeable battery and having the above operation, reduces battery resistance and prolongs the battery life.

Modifications

The present embodiment may be modified as described below. The present embodiment and the following modifications can be combined if the combined modifications remain technically consistent with each other.

The active material layer 22 may be arranged on both surfaces of the current collector 21.

The non-aqueous electrolyte rechargeable battery does not need to be a lithium ion battery. For example, the present disclosure may be applied to a nickel-hydrogen battery.

Technical concepts obtainable from the above embodiments are listed below as clauses.

[Clause 1]

An electrode body of a non-aqueous electrolyte rechargeable battery, the electrode body including: a positive electrode; a negative electrode; and a separator arranged between the positive electrode and the negative electrode, where the negative electrode includes a current collector and an active material layer applied to at least one surface of the current collector, the active material layer includes active material particles of different particle sizes formed from a carbon material, the active material particles have a volume distribution with respect to particle size, the volume distribution including a first peak corresponding to a first particle size and a second peak corresponding to a second particle size that is smaller than the first particle size, the first particle size is in a range of 7.0 μm to 9.0 μm, the second particle size is in a range of 0.8 μm to 1.0 μm, the separator has a surface roughness of 1.54 μm or greater, and a peak ratio that is a ratio of a volume of the active material particles of the second peak to a volume of the active material particles of the first peak is in a range of 0.42 to 0.71.

The inventor of the present application found the following relationship among the surface roughness of the separator, the peak ratio, the DC resistance value of a battery at 25° C., and the battery capacity retention rate after ten days when the first particle size was in the range of 7.0 μm to 9.0 μm and the second particle size was in the range of 0.8 μm to 1.0 μm. In the rechargeable battery of the comparative example, the surface roughness of the separator was 1.07 μm and the peak ratio was 0.12. When the surface roughness of the separator was 1.54 μm or greater and the peak ratio was in the range of 0.42 to 0.71, the DC resistance ratio of the rechargeable battery of the above configuration to that of the comparative example was 98.69% or less. The battery capacity retention ratio of the rechargeable battery of the above structure after ten days to that of the comparative example was 97% or greater.

Thus, the above configuration reduces the battery resistance and prolongs the battery life.

[Clause 2]

The electrode body of a non-aqueous electrolyte rechargeable battery according to Clause 1, where the surface roughness of the separator is 2.29 μm or greater, and the peak ratio is in a range of 0.42 to 0.61.

With this configuration, when the surface roughness of the separator was 2.29 μm or greater and the peak ratio was in the range of 0.42 to 0.61, the DC resistance ratio of the rechargeable battery of the above configuration to that of the comparative example was 97.7% or less. The battery capacity retention ratio of the rechargeable battery of the above structure after ten days to that of the comparative example was 97%.

Thus, the above configuration further reduces battery resistance.

[Clause 3]

A non-aqueous electrolyte rechargeable battery, including: the electrode body according to Clause 1 or 2; a non-aqueous electrolyte; and a battery case accommodating the electrode body and the non-aqueous electrolyte.

This configuration has the same operational advantages as those of Clause 1.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An electrode body of a non-aqueous electrolyte rechargeable battery, the electrode body comprising:
a positive electrode;
a negative electrode; and
a separator arranged between the positive electrode and the negative electrode, wherein
the negative electrode includes a current collector and an active material layer applied to at least one surface of the current collector,
the active material layer includes active material particles of different particle sizes formed from a carbon material,
the active material particles have a volume distribution with respect to particle size, the volume distribution including a first peak corresponding to a first particle size and a second peak corresponding to a second particle size that is smaller than the first particle size,
the first particle size is in a range of 7.0 μm to 9.0 μm,
the second particle size is in a range of 0.8 μm to 1.0 μm,
the separator has a surface roughness of 1.54 μm or greater, and
a peak ratio that is a ratio of a volume of the active material particles of the second peak to a volume of the active material particles of the first peak is in a range of 0.42 to 0.71.

2. The electrode body of a non-aqueous electrolyte rechargeable battery according to claim 1, wherein
the surface roughness of the separator is 2.29 μm or greater, and
the peak ratio is in a range of 0.42 to 0.61.

3. A non-aqueous electrolyte rechargeable battery, comprising:
the electrode body according to claim 1;
a non-aqueous electrolyte; and
a battery case accommodating the electrode body and the non-aqueous electrolyte.
